(19) United States
(12) Patent Application Publication
(10) Pub. No.: US 2009/0051773 A1
(43) Pub. Date: Feb. 26, 2009

(54) VIDEO CAPTURE DEVICE WITH ATTENTION ATTRACTIVE FEATURE

(76) Inventor: Yu-Wei Lin, Jhongli City (TW)

Correspondence Address: Anthony R. Barkume, 20 Gateway Lane, Manorville, NY, 11949, US

(21) Appl. No.: 12/142,049

(22) Filed: Jun. 19, 2008

(30) Foreign Application Priority Data
Aug. 20, 2007 (TW) 096213834

(51) Int. Cl. H04N 5/225

(52) U.S. Cl. 348/207.99; 348/E05.024

(57) ABSTRACT

A video capture device with attention attractive feature comprising: a video capture device; an attention attractive device, connecting to the video capture device; wherein the attention attractive device is used to attract the sight of eyes for video capture device to capture a better image.

### FIELD OF THE INVENTION

The present invention relates to a video capture device with attention attractive feature, especially for the device which is able to make special audio signals, light, or mechanical structure activities to attract the sight and attention of models when taking a shot.

### BACKGROUND OF THE INVENTION

Electrical products improve very fast with the high improvement speed of technology implement. The traditional cameras and video cameras which capture and record image by using traditional films both evolve to electrical devices for capturing and storing image, this way is able to provide the captured image to the users directly by the LCD screens on the cameras or video camera, and the digitized video image will be more easily stored and transported. Further more, the resolution of camera and video camera lens are higher and higher, the optical zoom and digital zoom also become more and more powerful with more features.

Although the features and resolution of traditional cameras and video cameras both have great improvement, concerning the user behavior, they still lack of the feature of attracting attention and make inconvenient to end users. For example, end users have to take the cameras in one hand and a toy or some other things to attract their sight in another when filming children or pats, to make children and pats focus at the lens for capturing better and nature pictures. This way to handle the camera or video camera in one hand usually causes the lens shaking or losing focus problems and increases the difficulty of making pictures. On the other hand, the end user cannot press the shutter until the children and pats face to the lens, which takes longer waiting time and more films for getting better image when making pictures.

There are several disadvantages in the technologies of traditional camera devices:

1. In the application of using traditional cameras and video cameras, there is no any device to attract the sight and attention of children and pats.

2. In the application of using traditional cameras and video cameras, the camera or video camera has to be handled by one hand and attracting children and pats sight by another when filming the children or pats, which increases the difficulty of making pictures.

3. In the application of using traditional cameras and video cameras, it takes longer waiting time and more films in order to get a better and nature images on children or pats.

Therefore, how to improve the above traditional disadvantages to allow video capture devices provide feature of attracting attention, is the major topic of the present invention.

### SUMMARY OF THE INVENTION

An objective of the present invention is to provide a new and advanced video capture device with attention attractive feature, which integrates an attention attractive device within the video capture device, to attract the sight and attention of models by making special audio signals, light effects, or mechanical structure activities when filming the persons or animals, in order to capture better and natural video image.

According to the present invention, a video capture device with attention attractive feature comprising:

a video capture device;

an attention attractive device, connecting to the video capture device;

wherein the attention attractive device is used to attract the sight of eyes for video capture device to capture a better image.

In accordance with one aspect of the present invention, the attention attractive device is used to attract the attention of persons.

In accordance with one aspect of the present invention, the attention attractive device is used to attract the attention of pats.

In accordance with one aspect of the present invention, the attention attractive device uses a voice signal to attract attention.

In accordance with one aspect of the present invention, the attention attractive device contains a record unit to record a period of voice.

In accordance with one aspect of the present invention, the attention attractive device also contains a playback unit to playback the special voice.

In accordance with one aspect of the present invention, the attention attractive device uses a light to attract attention.

In accordance with one aspect of the present invention, the attention attractive device uses a mechanical structure executing an activity to attract attention.

In accordance with one aspect of the present invention, the mechanical structure activity can be a waving activity, a shaking activity, a moving activity, or a regular moving activity.

In accordance with one aspect of the present invention, the video capture device unit is a camera.

In accordance with one aspect of the present invention, the video capture device unit is a video camera.

The present invention may best be understood through the following description with reference to the accompanying drawings, in which:

### BRIEF DESCRIPTION OF THE DRAWINGS

FIG. 1 shows the structure diagram of the video capture device with attention attractive feature according to the present invention, which uses voice to attract models.

FIG. 2 shows the structure diagram of the video capture device with attention attractive feature according to the present invention, which uses light to attract models.

FIG. 3 shows the structure diagram of the video capture device with attention attractive feature according to the present invention, which uses mechanical structure activity to attract models.

### DETAILED DESCRIPTION OF THE INVENTION

FIG. 1 shows the structure diagram of the video capture device with attention attractive feature according to the present invention by noise, which contains a video capture device unit 11, an attention attractive device 12, a recording unit 13, and a playback unit 14.

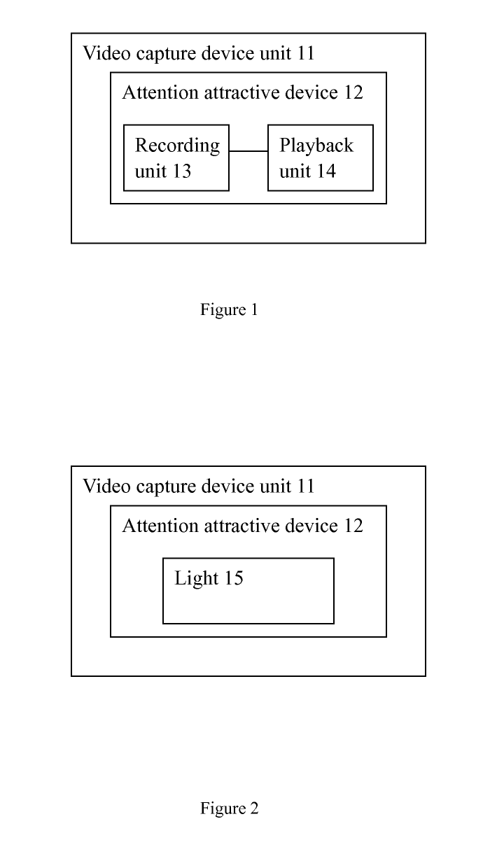

FIG. 2 shows the structure diagram of the video capture device with attention attractive feature according to the present invention by light, which contains a video capture device unit 11, an attention attractive device 12, and a light 15.

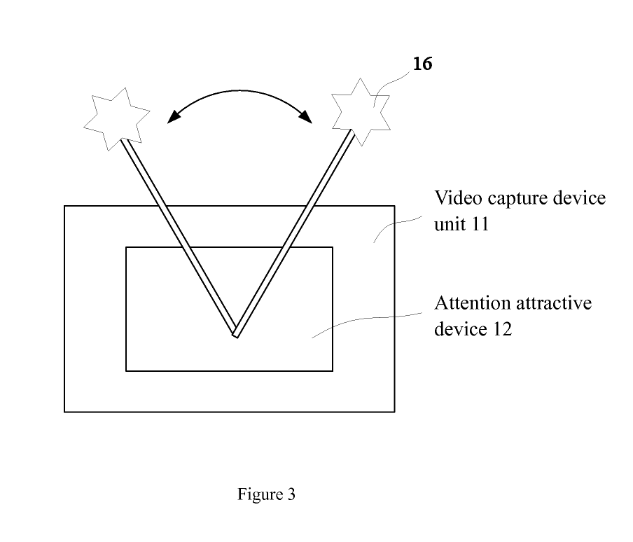

FIG. 3 shows the structure diagram of the video capture device with attention attractive feature according to the present invention by mechanical structure activity, which contains a video capture device unit 11, an attention attractive device 12, and a mechanical structure 16.

In accordance with the video capture device with attention attractive feature, the attention attractive device 12 within the video capture device unit 11 is able to attract the persons or animals to the attention attractive device 12 firstly and make their sight focus at the lens of video capture unit 11 when filming the models, in order to get a better video image.

Video capture device unit 11 can be a camera, a video camera, a video system, or any other device with video capture feature, for example a camera in a mobile phone. Attention attractive device 12 can be a device within record unit 13 and playback unit 14. Through record unit 13, a user is able to record a period of voice which is very attractive to children or pats in the record device 12, and playback this preloaded voice to attract the sight and attention of children or pats by playback unit 14 when filming them, in order to get a better video image when they look at the lens. Of course, playback unit 14 also can preload many sound effects, such as thundering, ringing, music, animal's yelling, or knocking, etc.; and record unit 13 can also preload many sound effects, such as laughing, shouting, calling, or some specific person's voice, etc. Furthermore, a frequency converter may be used for generating different sound effects.

Attention attractive device 12 can also be a device with light 15, to flash light or shine colorful effects to attract attention during filming. Further more, attention attractive device 12 can also be a device with mechanical structure activities. Mechanical structure 16 can be a moving arm or an acting doll to attract children or pats attention.

There are several advantages of the present invention:

1. In accordance with the video capture device with attention attractive feature of the present invention, it can make special voice, light, or mechanical structure activity to attract the attention of children or pats by the attention attractive device, in order to get better and nature video image.

2. In accordance with the video capture device with attention attractive feature of the present invention, it can record a period of attractive voice in advance and place it back during filming to attract the attention of models.

To sum up, the video capture device with attention attractive feature of the present invention integrate the attention the attention attractive device within the video capture device, to attract the attention of models firstly before filmed for better and nature video image. Any other modified design of video capture device or attention attractive device, once a video capture device with attention attractive feature belongs to the protection field of the present invention.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims to be accorded with the broadest interpretation so as to encompass all such modifications and similar solutions.

What is claimed is:

1. A video capture device with attention attractive feature comprising:
a video capture device;
an attention attractive device, connecting to the video capture device;
wherein the attention attractive device is used to attract the sight of eyes for video capture device to capture a better image.

2. A video capture device with attention attractive feature according to claim 1 wherein the attention attractive device is used to attract the attention of persons.

3. A video capture device with attention attractive feature according to claim 1 wherein the attention attractive device is used to attract the attention of pats.

4. A video capture device with attention attractive feature according to claim 1 wherein the attention attractive device uses a voice signal to attract attention.

5. A video capture device with attention attractive feature according to claim 1 wherein the attention attractive device contains a record unit to record a period of voice.

6. A video capture device with attention attractive feature according to claim 5 wherein the attention attractive device also contains a playback unit to playback the special voice.

7. A video capture device with attention attractive feature according to claim 1 wherein the attention attractive device uses a light to attract attention.

8. A video capture device with attention attractive feature according to claim 1 wherein the attention attractive device uses a mechanical structure executing an activity to attract attention.

9. A video capture device with attention attractive feature according to claim 8 wherein the mechanical structure activity can be a waving activity, a shaking activity, a moving activity, or a regular moving activity.

10. A video capture device with attention attractive feature according to claim 1 wherein the video capture device unit is a camera.

11. A video capture device with attention attractive feature according to claim 1 wherein the video capture device unit is a video camera.
